(19) United States
(12) Patent Application Publication
(10) Pub. No.: US 2009/0235623 A1
(43) Pub. Date: Sep. 24, 2009

(54) DEVICE FOR DEPOLLUTING EXHAUST GASES OF A THERMAL ENGINE

(75) Inventor: Gerard Lerdung, Mathay (FR)

Correspondence Address: YOUNG & THOMPSON, 209 Madison Street, Suite 500, ALEXANDRIA, VA, 22314, US

(73) Assignee: FAURECIA SYSTEMES D'ECHAPPEMENT, Mathay (FR)

(21) Appl. No.: 11/721,390

(22) PCT Filed: Dec. 9, 2005
(86) PCT No.: PCT/FR05/03096

§ 371 Date: Jun. 11, 2007

(30) Foreign Application Priority Data
Dec. 10, 2004 (FR) 0413192

(51) Int. Cl. B01D 46/30; B01D 46/10

(52) U.S. Cl. 55/484; 55/502

(57) ABSTRACT

A device for depolluting a heat engine exhaust gases includes an outer casing (23) including successive first and second tubular sections (38, 40), the first section (38) containing a first depolluting member (18) mounted in the passage, the first section including a female end (42) wherein is nested a male end (44) of the second section (40). The first depolluting member (18) includes a substrate (19) and at least one wedge (50, 52) interposed between the inner surface of the first tubular section (38) and the substrate (19), the (or each) wedge (50, 52) consisting of a wire mesh associated with a heat-expansible material to provide exhaust gas proofness.

The present invention relates to a device for depolluting exhaust gases of a thermal engine of the type comprising an outer casing, the casing comprising first and second successive tubular portions containing, respectively, a first and a second depollution element which are mounted successively in the passage, the first portion comprising a female end in which a male end of the second portion is fitted.

A device of this type is used in particular for the depollution of motor vehicle diesel engines. In this case, it generally comprises, arranged in the same casing, a catalytic purification element and a particulate filter.

The catalytic purification element is suitable for processing polluting emissions in the gaseous phase, whilst the particulate filter is suitable for retaining the particles of soot discharged by the engine.

In the devices for petrol engines, a plurality of catalytic purification elements are arranged in the same casing.

It is known to form the depollution device in two portions which each comprise a tubular portion, inside which a depollution element is arranged. The two portions are fitted one inside the other and are retained in a fixedly joined state by means of a flange or hoop-like member. A device of this type is described, for example, in the patent applications FR-2 821 117 and FR-2 839 533.

The production of depollution devices of this type is relatively complex since it requires the use of means which allow correct axial positioning of the two portions before the joining device is positioned.

The object of the invention is to provide a device for depolluting exhaust gases which can be readily produced and can therefore have a low cost.

To this end, the invention relates to a device for depolluting exhaust gases of the above-mentioned type, characterised in that the male end has, at the end thereof, an axial stop surface which is in abutment against the first depollution element contained in the first portion.

According to specific embodiments, the device comprises one or more of the following features:
the axial stop surface is defined by an inner collar which is provided at the end of the male end;
the inner diameter of the inner collar is less than the cross-section of the face opposite the first depollution element;
the first portion comprises, opposite the female end relative to the first depollution element, a peripheral shoulder on which the first depollution element is supported axially;
the first depollution element comprises a substrate and a wedge which is interposed between the axial stop surface and the substrate;
the second depollution element is in axial abutment against the inner collar;
the female and male ends which are fitted one inside the other are welded to each other by means of a peripheral weld seam; and
the female and male ends which are fitted one inside the other are connected to each other by means of a hoop-like collar in which associated profiles of the female and male ends are fitted.

The invention will be better understood from a reading of the following description, given purely by way of example and with reference to the drawings, in which:

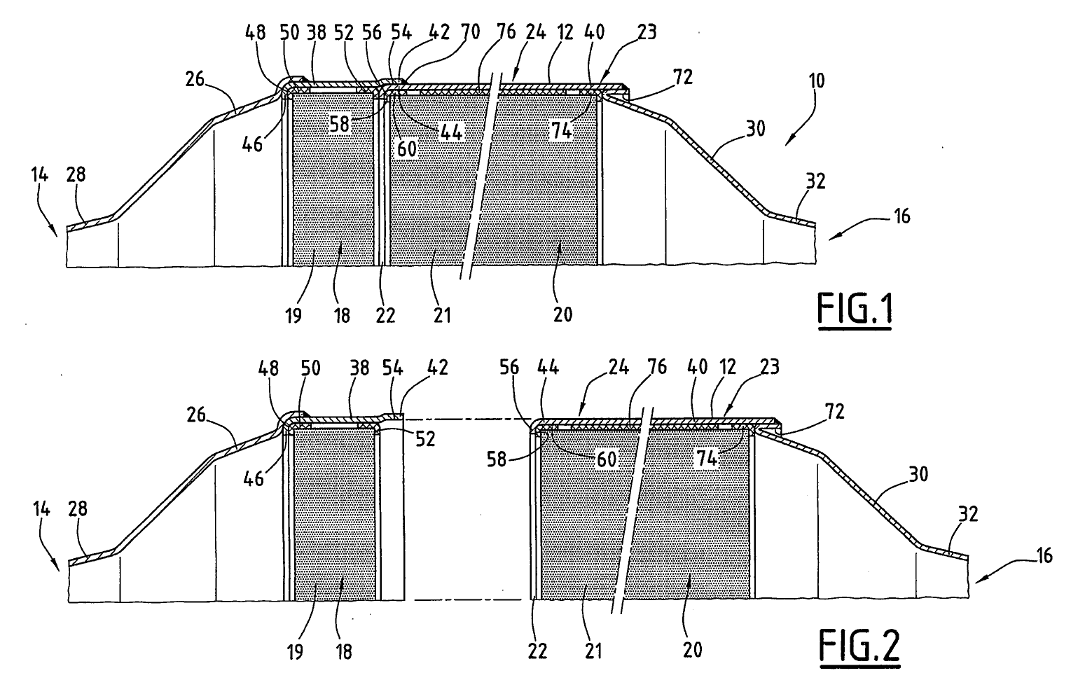

FIG. 1 is a longitudinal section of the depollution device according to the invention;

FIG. 2 is a longitudinal section of the depollution device before two successive portions are assembled; and

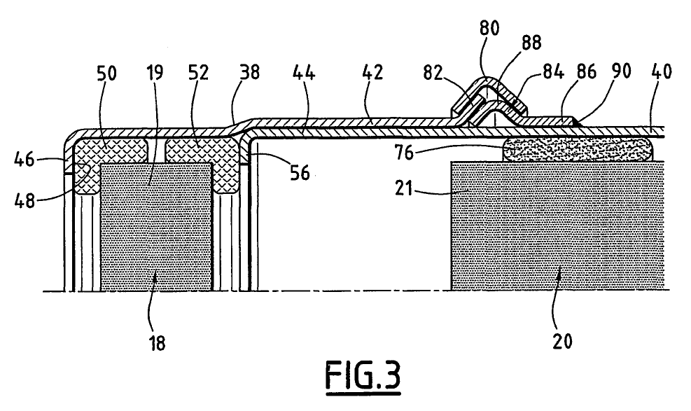

FIG. 3 is a partial longitudinal section of the coupling of two successive portions according to another embodiment.

The depollution device 10, illustrated in FIG. 1, comprises an exhaust chamber 12 which is generally cylindrical and which has, at one end, an inlet 14 and, at the other end thereof, an outlet 16. A catalytic purification element 18 and a particulate filter 20 which are separated by a free transition space 22 are arranged successively from the inlet to the outlet inside the chamber 12.

The exhaust chamber 12 comprises an outer casing 23 which delimits a passage for circulation of exhaust gases through which the catalytic purification element 18 and the particulate filter 20 are arranged.

The catalytic purification element 18 comprises, for example, a gas-permeable structure 19 which is coated with catalytic metals which promote the oxidation of combustion gases and/or the reduction of nitrogen oxides.

The particulate filter 20 comprises a filtration material which is constituted by a monolithic structure 21 of ceramic material or silicon carbide and which has sufficient porosity to allow the passage of exhaust gases. However, as known per se, the diameter of the pores is selected to be sufficiently small to ensure that particles are retained, and in particular particles of soot, on the upstream face of the filter. The particulate filter can also be produced from a ceramic foam, cordierite or silicon carbide. It may also be constituted by a cartridge filter or a filter of sintered metal.

The particulate filter used in this instance comprises, for example, an assembly of parallel channels which are divided into a first group of inlet channels and a second group of outlet channels. The inlet and outlet channels are arranged in a zig-zag arrangement.

The inlet channels open in the upstream cross-section of the particulate filter and are blocked in the region of the downstream cross-section of the particulate filter.

Conversely, the outlet channels are blocked in the upstream cross-section of the particulate filter and open in the downstream cross-section thereof.

In the current portion thereof, the outer casing 23 is formed by a cylindrical wall 24 having a substantially constant cross-section.

At the inlet end thereof, the chamber comprises a divergent portion 26 which connects an inlet pipe 28 to the cylindrical wall 24. In the same manner, at the rear end thereof, the cylindrical wall 24 is extended by a convergent portion 30 which terminates in an outlet pipe 32 which delimits the outlet 16.

During operation, the exhaust gases first flow through the catalytic purification element 18 then through the particulate filter 20.

The casing 23 is delimited, in the example in question, by two successive tubular portions 38, 40 which are coupled to each other and which contain, respectively, the catalytic purification element 18 and the particulate filter 20. Each portion is formed by a rolled hoop whose two longitudinal edges are connected to each other along a longitudinal connection which is formed by means of welding or crimping.

The upstream portion 38, when viewed in the normal flow direction of the gas, has, at the downstream end thereof, a widened female end 42 in which there is axially engaged the upstream end of the portion 40 which forms a male end designated 44.

The portion 38 has, at the upstream end thereof, a recessed collar 46 which forms, at the inner side, a shoulder 48 for abutment against the catalytic purification element 18.

The catalytic purification element 18 comprises, in addition to the gas permeable structure 19, a wedge 50 (an element for blocking in position) which is interposed between the periphery of the upstream face of the structure 50 and the shoulder 48. This wedge extends along the lateral wall of the structure 19.

The wedge 50 is formed by an annular joint which generally has, in cross-section, an L-shape, of which one branch is supported on the shoulder 48 and the other branch is supported on the lateral surface of the structure 19.

A wedge 52, which is identical to the wedge 50, is engaged at the periphery of the downstream face of the structure 19 and also extends partially along the lateral surface of the structure. The branch of the wedge which overlaps, at the periphery thereof, the downstream surface, forms a support seat for the end of the male end 44 of the second portion 40.

The two wedges 50, 52 define an axial clearance between the shoulder 48 and the upstream face of the substrate 19 which is in the order of 5.5 mm whilst the radial clearance defined between the lateral surfaces opposite the substrate 19 and the portion 38 is in the order of 3.5 mm.

These two wedges are formed by a metal trellis of the type ACS LSP 5600 supplied by the company ACS. Only the upstream wedge 50 is associated with a heat-expandable material of the vermiculite type which allows sealing with respect to the exhaust gases.

Beyond the wedge 52, the portion 38 has a widened portion 54 which forms the female end 42.

The second portion 40 has, at the end of the male end 44, a recessed peripheral collar 56 which delimits internally a shoulder 58 for supporting the particulate filter 20. The collar 56 has, at the inner side, a cross-section which is less than the periphery cross-section of the downstream face of the porous structure 19, in order to be supported thereon by means of the wedge 52, forming a stop.

The substrate 21 of the particulate filter is supported with the upstream face thereof on the shoulder 58 with a wedge 60 being interposed which is formed by an annular joint which has an L-shaped cross-section, one branch of which is interposed between the shoulder 58 and the periphery of the upstream face of the substrate 21 and the other wing of which extends between the lateral wall of the substrate and the lateral wall of the second portion 40.

The connection between the first and second portions 38, 40 is provided by a peripheral weld seam 70 which is formed at the end of the female end 42 against the lateral wall 40 of the second portion.

The first and second portions 38, 40 are connected by being fitted to the divergent portion 26 and the convergent portion 30, respectively.

More precisely, the divergent portion 26 has, at the periphery thereof having the largest diameter, a widened end in which the upstream end of the first portion 38 is fitted, the collar 46 being supported on the shoulder of the divergent portion 46 formed by the widened end.

The widened end of the convergent portion 30 is fitted at the inner side of the downstream end of the second portion 40. To this end, it has a generally cylindrical outer edge 72 which is capable of pressing against the inner surface of the wall 40. The convergent portion 30 presses against the substrate 21 of the particulate filter with a wedge 74 being interposed which is formed by a joint which is identical to the wedge 60.

The wedges 60 and 74 define an axial clearance in the order of 5 mm and a radial clearance in the order of 3.5 mm.

The wedges are, for example, of the type LSP-5600.45 from the company ACS. They differ from the wedges 50 and 52 in that they are more dense in order to better absorb the forces of the particulate filter 20.

Furthermore, the substrate 21 is surrounded in the current portion thereof by a retention sheet 76 which is interposed between the substrate and the inner surface of the portion 40. This sheet is formed, for example, from ISOMAT AV 3280 g/m² from the company Unifrax.

For assembly, and as illustrated in FIG. 2, the catalytic purification element is first engaged inside the first portion 48, the wedges 50 and 52 being interposed between the substrate 19 and the first portion 38.

In the same manner, the substrate 21 of the particulate filter is engaged with the two wedges 60, 74 in the second portion 40. The substrate is held in abutment against the shoulder 58 by the convergent portion 30 which is fitted in the second portion 40 from the rear end. In this manner, the substrate 21 is held secure between the shoulder 58 and the edge of the convergent portion 30. The substrate 21 is held with a compression force of 4000N imposed by the convergent portion 30.

The male end 44 of the second portion is fitted in the female end 42 of the first portion until the collar 56 which forms a stop comes into abutment against the wedge 52 in order to ensure axial locking of the substrate 19 of the catalytic purification element, this substrate being retained between the shoulder 48 and the stop 56 which is formed by the inner collar which is provided at the end of the male end 44. The fitting force compressing the catalytic purification element 18 between the two support surfaces is controlled and is adjusted in accordance with the forces. This force is preferably between 1500 and 5000 N and is, for example, in the order of 2000 N.

It should be understood that, in a depollution device of this type, the substrate 19 of the catalytic purification element is retained axially only by fitting the male end 44 which is provided with the collar 56 in the female end 42. In the same manner, the abutment of the male end of the second portion against the substrate 19 and via the substrate 19 against the shoulder 48 allows axial positioning of the first and second portions 38, 40 relative to each other.

In this manner, with an arrangement of this type, the collar 56 allows both locking of the substrate 19 and correct positioning of the first and second portions, which ensures a lower production cost of the depollution device.

In the embodiment envisaged above, the collar 56 also provides a stop function for the substrate 21 of the particulate filter.

In the embodiment of FIG. 3, elements which are identical or similar to those of the first embodiment have been given the same reference numerals.

The second portion 40 is equipped, at the end of the male end, as above, with an inner collar 56. However, the substrate 21 of the particulate filter is not in abutment against the collar 56 but is retained axially inside the second portion 40 by the intermediate sheet 76 which is interposed between the lateral surface of the substrate 21 and the lateral wall of the second portion 40.

Furthermore, and in order to allow releasable fixing of the first and second portions 38, 40, in particular in order to clean the upstream face of the particulate filter, the first and second portions are connected by means of a removable collar 80 which surrounds a curved end edge 82 formed at the end of the female end 44 and a strip 84 which is fixedly joined to the outer surface of the portion 40, the edge 82 being pressed against the strip 84 and both being retained inside the V-shaped profile of the collar 80.

In the embodiment envisaged, the strip 84 is formed by an curved hoop which has a flat portion 86 which is extended with a portion 88 having a V-shaped cross-section which has two flanks which are inclined relative to each other by 90° and which forms the strip itself. The hoop is connected to the outer surface of the second portion 40 by means of a weld seam 90.

Also in this embodiment, the axial positioning of the first and second portions, and the locking in position of the substrate 19 are provided by the inner collar 56. Furthermore, the locking of the collar 80 retains the depollution element 18 by means of compression, in so far as the collar 80 surrounds the substrate 19.

According to another embodiment, more than two portions are fitted successively. Each of them has a female end at the downstream end thereof, viewed in the flow direction, and a male end at the upstream end thereof, the male end of a portion being fitted in the female end of the adjacent portion.

In order to provide sealing with respect to gases at the periphery of the purification element 18, it is possible to provide a heat-expandable sheet between the wedges 50 and 52. If the depollution element 18 has a length less than 40 mm, it is no longer possible to position a sheet and it becomes necessary to use wedges alone to provide sealing with respect to gases.

The device of the invention is particularly suitable for those cases in which a short ceramic is used. A ceramic is said to be short when the length/diameter ratio is less than 0.5.

Advantageously, the wedges 50, 52 which are positioned at each corner of the depollution element 18 allow the element to be retained securely fixed to the inner side of the portion 38 whilst providing sealing between the body of the portion 38 and the substrate 19.

When the depollution element 18 has a length/diameter ratio of less than 0.5, a maintenance sheet, that is to say, a material which surrounds the circumference of the element 18, cannot be used in order to retain the depollution element in the portion 38 owing, on the one hand, to the small contact surface-area between the lateral surface of the depollution element and the surface of the portion 38 and, on the other hand, the strong vibrations to which the device is subjected during operation. The small surface-area is linked to the shortness of the depollution element 18.

Advantageously, the collar 56 is short and extends only in an axial direction towards the inner side of the portion 38. This collar is in abutment against a face of the wedge 52 in order to ensure that the wedge is held in position.

1. Device for depolluting exhaust gases of a thermal engine, comprising an outer casing (23), the casing (23) comprising first and second successive tubular portions (38, 40), the first portion (38) containing a first depollution element (18) mounted in the passage, the first portion (38) comprising a female end (42) in which a male end (44) of the second portion (40) is fitted, characterised in that the first depollution element (18) comprises a substrate (19) and at least one wedge (50, 52) interposed between the inner surface of the first tubular portion (38) and the substrate (19), the or each wedge (50, 52) being formed by a metal trellis associated with a heat-expandable material in order to provide sealing with respect to exhaust gas.

2. Depollution device according to claim 1, characterised in that the or each wedge (50, 52) is capable of retaining the substrate (19) in the first tubular portion (38).

3. Depollution device according to claim 1, characterised in that the ratio of length to diameter of the first depollution element (18) is less than 0.5.

4. Depollution device according to claim 1, characterised in that the or each wedge (50, 52) is formed by an annular L-shaped joint.

5. Device according to claim 4, characterised in that the first portion (38) comprises, opposite the female end (42) relative to the first depollution element (18), a peripheral shoulder (46) on which the first depollution element (18) is supported axially, and in that a branch of this L-shaped wedge (50) is supported on the shoulder (46) and the other branch of the wedge (50) is supported on the lateral surface of the substrate (19).

6. Depollution device according to claim 4, characterised in that the male end (44) has, at the end thereof, an axial stop surface (56) which is in abutment against a branch of the wedge (52) in order to retain the wedge (52) in position.

7. Depollution device according to claim 6, characterised in that the axial stop surface is defined by an inner collar (56) which is provided at the end of the male end (44), the collar extends only in an axial direction towards the inner side of the first portion (38).

8. Depollution device according to claim 6, characterised in that the second portion (40) contains a second depollution element (20) which is mounted in the passage, the second depollution element (20) being in axial abutment against the axial stop surface (56).

9. Depollution device according to claim 1, characterised in that no maintenance sheet other than the or each wedge (50, 52) is interposed between the substrate (19) and the inner surface of the first tubular portion (38).

10. Depollution device according to claim 1, characterised in that the fitted female and male ends (42, 44) are connected to each other by means of a hoop-like collar (80) in which associated profiles (82, 84) of the female end (42) and male end (44) are fitted one into the other.

11. Depollution device according to claim 2, characterised in that the ratio of length to diameter of the first depollution element (18) is less than 0.5.

12. Depollution device according to claim 2, characterised in that the or each wedge (50, 52) is formed by an annular L-shaped joint.

13. Depollution device according to claim 3, characterised in that the or each wedge (50, 52) is formed by an annular L-shaped joint.

14. Depollution device according to claim 2, characterised in that no maintenance sheet other than the or each wedge (50, 52) is interposed between the substrate (19) and the inner surface of the first tubular portion (38).

15. Depollution device according to claim 3, characterised in that no maintenance sheet other than the or each wedge (50, 52) is interposed between the substrate (19) and the inner surface of the first tubular portion (38).

16. Depollution device according to claim 4, characterised in that no maintenance sheet other than the or each wedge (50, 52) is interposed between the substrate (19) and the inner surface of the first tubular portion (38).

17. Depollution device according to claim 5, characterised in that no maintenance sheet other than the or each wedge (50, 52) is interposed between the substrate (19) and the inner surface of the first tubular portion (38).

18. Depollution device according to claim 6, characterised in that no maintenance sheet other than the or each wedge (50, 52) is interposed between the substrate (19) and the inner surface of the first tubular portion (38).

19. Depollution device according to claim 7, characterised in that no maintenance sheet other than the or each wedge (50, 52) is interposed between the substrate (19) and the inner surface of the first tubular portion (38).

20. Depollution device according to claim 8, characterised in that no maintenance sheet other than the or each wedge (50, 52) is interposed between the substrate (19) and the inner surface of the first tubular portion (38).
